(19) United States
(12) Patent Application Publication
(10) Pub. No.: US 2025/0269457 A1
(43) Pub. Date: Aug. 28, 2025

(54) ESD WELDING APPARATUS AND METHOD

(71) Applicant: Huys Industries Limited, Etobicoke (CA)

(72) Inventors: Serkan KUNT, North York (CA); Kevin CHAN, North York (CA)

(21) Appl. No.: 18/584,599

(22) Filed: Feb. 22, 2024

(51) Int. Cl. B23K 9/12; B23K 9/28

(52) U.S. Cl. CPC B23K 9/122; B23K 9/28

(57) ABSTRACT

A welding electrode apparatus may be mounted to a programmable motion controller such as a robot that presents it to a workpiece along a pre-programmed path conforming to the workpiece surface. The apparatus has a first drive for rotating the welding electrode about its own axis. The welding electrode holder is part of a welding electrode had that is mounted to, or includes, an adapter that itself mounts to a programmable robot. The welding head is sprung on the adapter, such that application of the welding rod against the workpiece under a given force deflects the springs. The adapter can be adjusted in real time relative to the robot to smooth out variations in application force. The apparatus uses Hall effect sensors to sense deviations from a datum of spring displacement or force, and has a servo-motor to re-adjust positioning of the welding head relative to the robot.

### FIELD OF THE INVENTION

This Application relates to an Electro-Spark Discharge (ESD) tool for holding an electrode, and operation thereof.

### BACKGROUND OF THE INVENTION

In a number of industries it may be helpful to be able to coat a metal substrate having certain desired qualities with a coating of a dissimilar material having other properties. For example, in some cases it may be desirable to coat a metal substrate with a ceramic surface coating. Sometimes the coating is added for wear or corrosion resistance, or to return it to original dimensions. In the electro-spark deposition (ESD) process, a consumable electrode material is brought into contact with a metallic base surface to be treated to deposit a coating on the metallic substrate. The coating may be a ceramic or a metallic layer of a given metal or metal alloy. In each instance, it may be helpful to deposit the ESD coating with a measure of consistency in the hope of obtaining roughly consistent resultant properties in the coated area.

One such application may be for the coating of existing parts by a deposition process. Another application may occur where it is desired to remove or repair defects in the surface of a substrate, whether as a planar surface or as part of a non-planar three-dimensional object. Another application may pertain to welding electrodes for use in a production line for the sequential assembly of parts using a large number of welding stations. Welding electrodes are generally made of copper. The electrode may have a surface coating, such as a ceramic coating, that may be intended to increase electrode life. Other objects, such as steel may be provided with a surface coating, such as nickel or chrome. In other instances, coatings of vanadium-carbide, tungsten-carbide, titanium-diboride, zirconium-diboride, Titanium-carbide, Cr₃C₂, and so on, might be applied to tool steels or aluminum, or other metals, as may be. Such treatments or coatings, or repairs may occur where it is desired to change the surface properties, or near surface properties of an object, such as hardness, or corrosion resistance or other property.

The surface area will be coated with a layer of the electrode material when swept by the electrode. The object to be coated or treated may be mounted to a moving device or jig. The condition of the contact may be dependent on the relative motion of the rod of depositing electrode coating material and the electrode cap to be coated.

### SUMMARY OF THE INVENTION

In an aspect of the invention there is an automated Electro Spark Discharge (ESD) welding apparatus combining a programmable motion controller such as a robot or CNC machine and an ESD welding head that is mounted to the programmable machine or robot. Using a robot as an example, the ESD welding head is movable to deflect relative to the robot according to a force-deflection characteristic. At least a first sensor is mounted to monitor at least one of (a) deflection of the welding head relative to the robot as compared to a datum deflection; and (b) force applied by the welding head against a workpiece relative to a datum value. The apparatus is adjustable in response to output from first sensor to urge the apparatus to maintain at least one of (a) and (b). The at least a first sensor is a Hall effect sensor.

In a feature of that aspect of the invention, the robot has a seat to which the welding head is mounted. The welding head has an electrode holder and an adapter. The adapter has a first part that mounted to the seat of the robot. The adapter has a second part to which the electrode holder is mounted. The first part is movable relative to the second part according to the force-deflection characteristic. In another feature, the first part is connected to the second part by at least one spring. In another feature, the second part is constrained to move in a single degree of freedom relative to the first part.

In another feature, the single degree of freedom is linear translation, and the linear translation has a predominant component of motion that is normal to instantaneous travel direction of the welding head. In a further feature, the deflection of the welding head relative to the robot has a maximum amplitude of less than 1 inch. In another feature, the robot is a multiple degree of freedom robot having at least a first extending arm mounted to a base, and the welding head is mounted to the arm distant from the base. In still another feature, the welding head includes a welding rod accommodation and a drive operable to spin a welding rod mounted in the accommodation. In a yet further feature the apparatus is operable to seek to maintain a constant deflection force between the robot and the welding head.

In another aspect of the invention there is an automated method of using a robot and an ESD welding head mounted to the robot to apply an ESD coating to a workpiece. The method includes providing an adapter having a first part and a second part. The first part is mounted to the robot. The welding head has a welding electrode holder mounted to the second part. The second part is movably mounted to the first part according to a force-deflection characteristic. The method includes using the robot to convey the welding head along a programmed path relative to the workpiece and using the welding head to deposit an ESD layer from a welding rod carried by the welding head onto the workpiece as the robot moves the welding head along the programmed path. The method includes monitoring the position of the second part relative to the first part while the welding head is depositing the ESD layer on the workpiece while it moves along the programmed part; and driving the first part to seek to maintain a constant force between the welding rod and the workpiece.

In a feature of that aspect, the first part and the second part are connected by at least a first spring and the method incudes monitoring deflection of at least the first spring and adjusting position of the first part to seek to maintain a constant deflection in at least the first spring. In another feature, the method includes spinning the welding rod at a speed that is less than 3000 rpm while monitoring position of the second part relative to the first part with sensors operating on a digital clock pulse rate of at least 800 kHz. In still another feature the method includes providing a welding head with a spring mass of at least ½ kg. In a further feature the method includes limiting maximum amplitude of motion between the first part and the second part to a maximum amplitude of 1 inch. In another feature, the method includes using at least one Hall effect sensor to monitor deflection of the welding head relative to the robot. In still another feature the method includes determining datum deflection of the welding head relative to the robot in a no-load condition throughout a set of orientations permitting calculation of a datum deflection correction that varies with welding head orientation during ESD deposition. In a further feature the method includes making at least a first ESD coating pass and a second ESD coating pass relative to the workpiece, and a different material composition is deposited in the second coating pass than in the first coating pass. In a additional feature the method includes providing a motor to adjust position of the first part relative to the robot to seek to conform to a datum deflection of the second part relative to the first part during ESD deposition on the workpiece. In still another feature, the method includes providing quick-release hand operable securements to hold the welding rod holder in a fixed position relative to the second part.

In another aspect of the invention there is any combination of any of the features of any one of embodiments shown or described herein, in combination with the features of any other embodiment, except to the extent those features are mutually exclusive. In another aspect of the invention, there is any apparatus substantially as shown or described herein, in whole or in part.

### BRIEF DESCRIPTION OF THE DRAWINGS

These aspects and other features of the invention can be understood with the aid of the following illustrations of a number of exemplary, and non-limiting, embodiments of the principles of the invention in which:

FIG. 1 shows a perspective view of a welding apparatus for holding a welding electrode mounted on a multi-axis robot;

FIG. 2a is a front view of an ESD welding apparatus mounting such as can be used in the multi-axis robot of FIG. 1;

FIG. 2b is a perspective view of the welding apparatus of FIG. 2a in position relative to a workpiece;

FIG. 3 is a side view of the ESD welding apparatus of FIG. 2a;

FIG. 4 is a left-hand side view of the apparatus of FIG. 3 with near-side exterior shell removed to reveal internal details;

FIG. 5 is a view of the welding apparatus of FIG. 3 taken on section ‘5-5’; and

FIG. 6 is a partially schematic sequence of views (a) to (c) of the apparatus of FIG. 5 demonstrating operation of the apparatus of FIG. 2a.

### DETAILED DESCRIPTION

The description that follows, and the embodiments described therein, are provided by way of illustration of an example, or examples, of particular embodiments of the principles of the invention. These examples are provided for the purposes of explanation, and not of limitation, of those principles and of the invention. In the description, like parts are marked throughout the specification and the drawings with the same respective reference numerals. The drawings may be understood to be to scale and in proportion unless otherwise noted. The wording used herein is intended to include both singular and plural where such would be understood, and to include synonyms or analogous terminology to the terminology used, and to include equivalents thereof in English or in any language into which this specification many be translated, without being limited to specific words or phrases.

For the purposes of this description, a Cartesian frame of reference may be employed. In such a frame of reference, the long, or largest, dimension of an object may be considered to extend in the direction of the x-axis, being the longitudinal axis and the main axis of rotation. The height of the object is measured in the z-direction, and the lateral distance from the central vertical plane is measured in the y-direction. Unless noted otherwise, the terms “inside” and “outside”, “inwardly” and “outwardly”, refer to location or orientation inside the housing of the apparatus. In this specification, the commonly used engineering terms “proud”, “flush” and “shy” may be used to denote items that, respectively, protrude beyond an adjacent element, are level with an adjacent element, or do not extend as far as an adjacent element, the terms corresponding conceptually to the conditions of “greater than”, “equal to” and “less than”. In this specification distinction may be made between materials that are thermal conductors and thermal insulators. In general, the thermal conductors may be thought of as materials such as metals, such as steel, stainless steel, copper sheathing, mild steel flashing, whether galvanized or otherwise, or aluminum sheeting or aluminum extrusions, painted or otherwise. The insulators may be thought of as materials such as wood, particle board, oriented strand board, composites, and plastics, whether fiber reinforced or otherwise.

The embodiments illustrated and described illustrate non-limiting examples in which the principles of the present invention are employed. It is possible to make other embodiments that employ the principles of the invention and that fall within the following claims. To the extent that the features of those examples are not mutually exclusive of each other, the features of the various embodiments may be mixed-and-matched, i.e., combined, in such manner as may be appropriate, without having to resort to repetitive description of those features in respect of each possible combination or permutation. The invention is not limited to the specific examples or details which are given by way of illustration herein, but only by the claims, as mandated by law. The claims are to be given the benefit of purposive interpretation to include equivalents under the doctrine of equivalents.

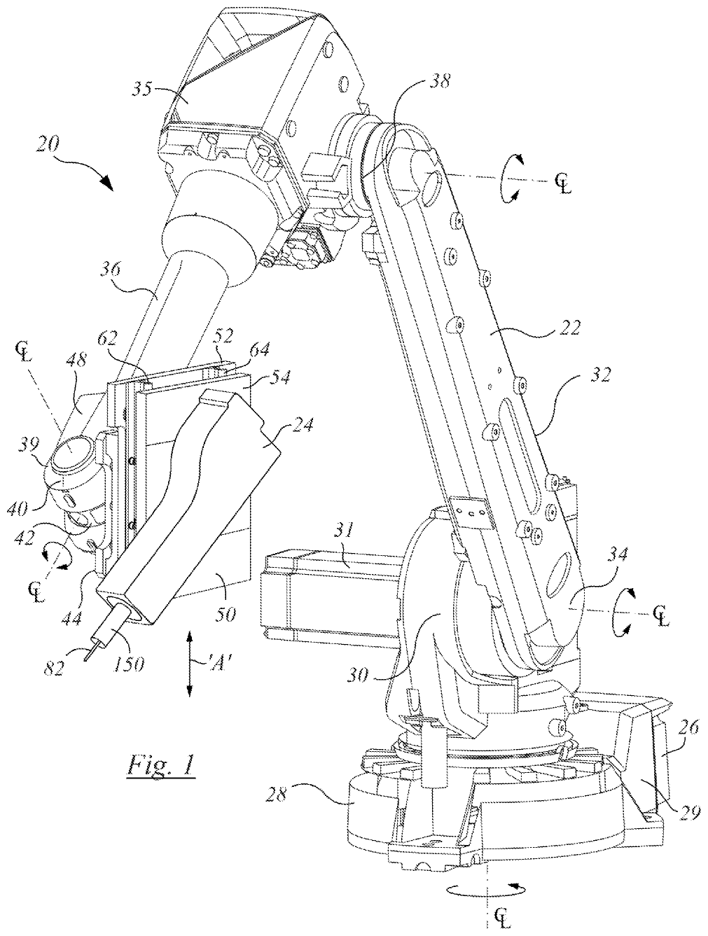

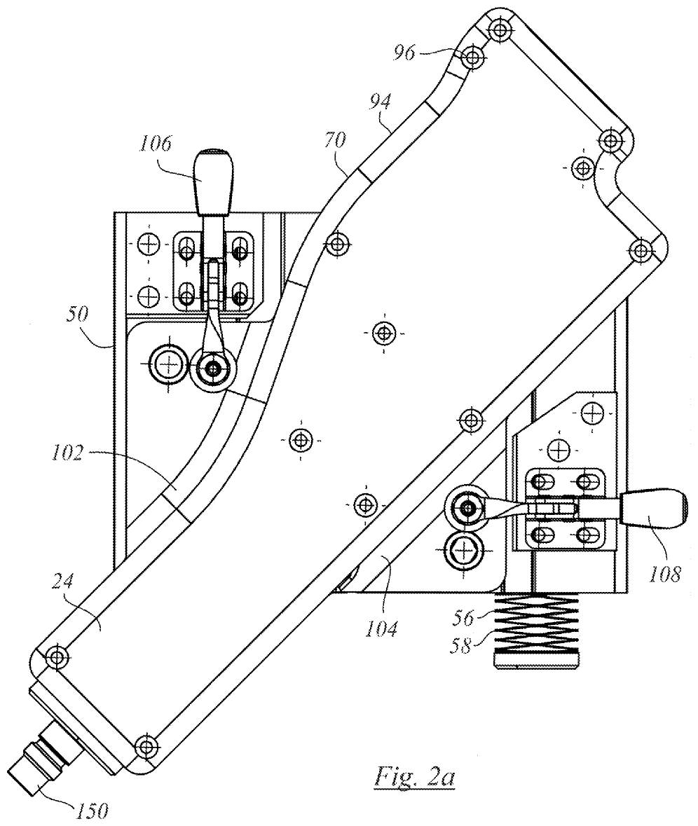

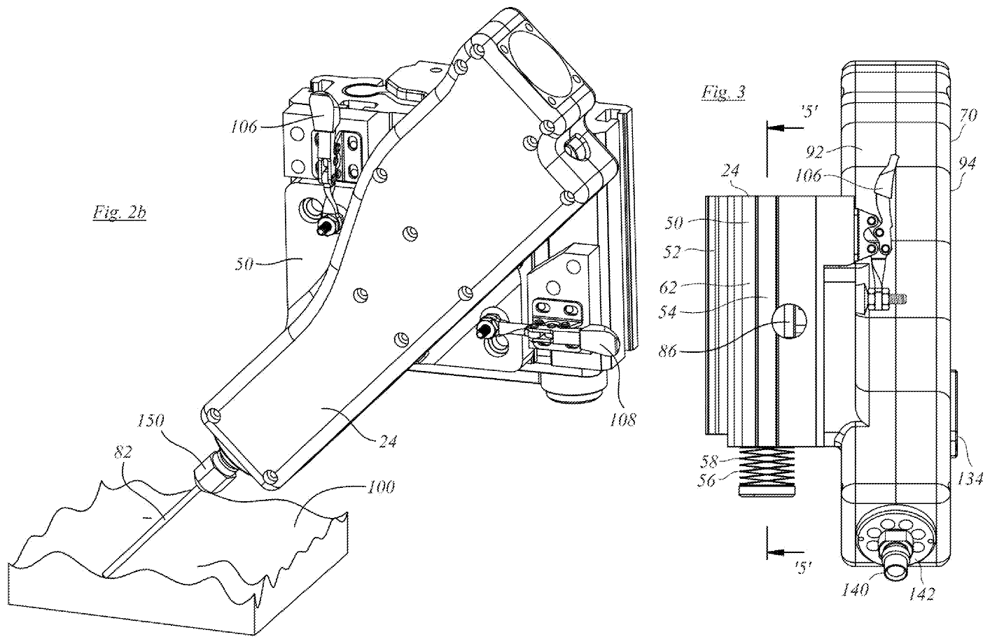

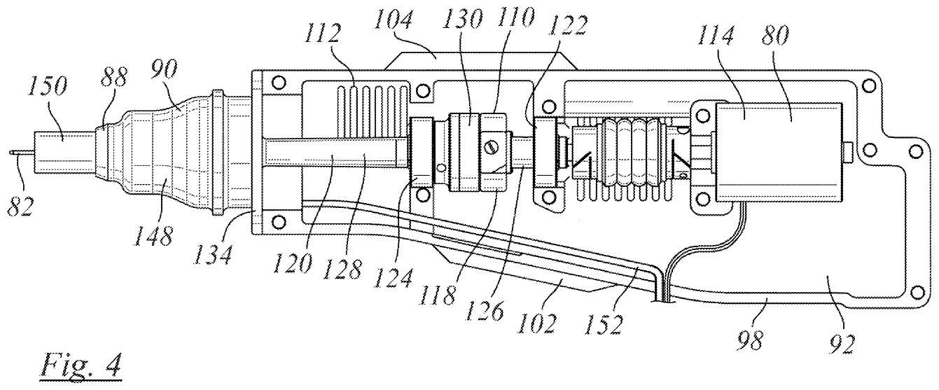

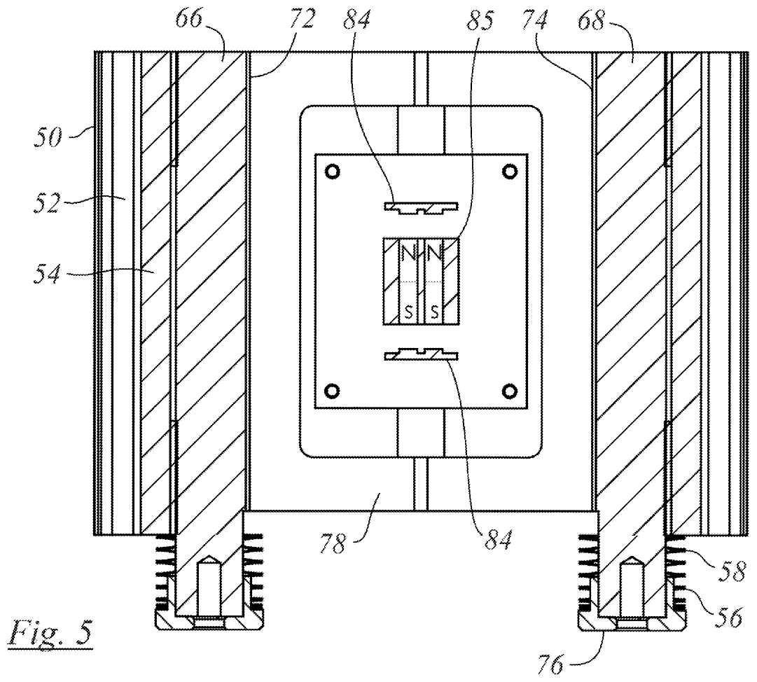

In FIG. 1 there is a low energy welding (LEW) apparatus 20. Low energy welding apparatus 20 may be, and in the embodiment illustrated is, an electro-spark discharge (ESD) welding system. Apparatus 20 includes a robot 22 and a low-energy welding assembly or welding head 24 mounted to robot 22. The automated low energy welding (LEW) applicator unit 24 is a welding or coating apparatus. It interfaces with, i.e., mounts on and operates in cooperation with, robot 22 and its power supply, notionally 26. The apparatus automatically applies LEW coatings, repairs and welds as programmed. That is, robot 22 is programmed to present the coating apparatus, i.e., the ESD applicator unit defined by welding head 24 to a workpiece according to a pre-programmed path, where the path may follow the surface of the workpiece, whether that surface is flat or has a curvature. It may follow a particular path, as in the circumstances in which the operation is to lay down a particular configuration of welding material, whether to follow a crack or defect in making a repair, or in building up a low energy weld of several passes, and so on for a contact area, and so on.

Robot 22 is a multiple degree of freedom robot, such as may be purchased commercially, as, for example, from ABB. In the example shown, the robot has a plinth, or base, 28 such as may be mounted to stationary structure (e.g., a concrete floor, or other pedestal), as may be. The workpiece is then positioned in a known location relative to robot 22. Robot 22 may include a laser sensing system to establish the relative location of the workpiece. The workpiece may itself be mounted on a pedestal or bed and may be stationary. Alternatively, the workpiece may be moving, as along an assembly line, whether continuously or intermittently, according to either a pre-determined path, or according to a path that can be sensed by the robot such that the relative position, orientation, and motion of the workpiece are known in the sense of robot 22 having the ability to correlate the path of tool operation to the workpiece. For case of explanation, it may be taken that the workpiece is stationary during welding or coating, unless otherwise noted, and that it is robot 22 that moves.

Robot 22 has a first degree of freedom, namely freedom of rotation about the vertical axis between the robot first member, or shoulder 30 and base 28. Robot 22 has a second degree of freedom of motion, namely angular rotation of upper arm 32 about the shoulder joint 34. Robot 22 has a third degree of freedom of motion, namely angular rotation of the forearm 36 relative to upper arm 32 about elbow joint 38. Elbow joint 38 may have an axis parallel to the pivot axis of shoulder joint 34. As such, motion of upper arm 32 and forearm 36 can place wrist 40 in a wide selection of positions in the radially extending plane perpendicular to the shoulder joint and elbow joint axes. Forearm 36 may have a further rotational degree of freedom about its long axis. Forearm 42 terminates at its distal end in a joint identified as wrist 40. Wrist 40 has a hand, or finger, or knuckle 48 that has a further rotational degree of freedom about the pivot axis of the joint of wrist 40. Welding head 24 of apparatus 20 has a mounting interface, or base, or plate 54 that mounts to knuckle 48 of robot 22. Knuckle 48 is carried on a spindle extending from wrist 40. That knuckle 48 may also have a rotational degree of freedom about its own longitudinal spindle axis such that plate 54 may be rotated. These multiple degrees of freedom permit the welding apparatus, or welding assembly, i.e., welding head 24, to be oriented in a wide variety of locations and orientations to engage the workpiece. Robot 22 includes a first drive 29 operable to move shoulder 30 relative to base 28; a second drive 31 operable to move upper arm 32 relative to shoulder 30; a third drive 35 operable to move forearm 36 relative to upper arm 32; a fourth drive 39 operable to rotate wrist 40; and a fifth drive 41 operable to move the knuckle, and therefore plate 44, relative to forearm 36. These drives may each have the form of an electric motor with appropriate gearing and position sensors.

Apparatus 20 has a head or carriage 50 that has a first member in the nature of an interface or base or footing 52 that engages plate 54 of robot 22. The engagement of footing 52 to plate 44 is a moving, or movable, engagement. In the embodiment illustrated footing 52 has slides, or grooves, that permit it to have linear displacement relative to plate 44. In the embodiment illustrated that displacement is vertical, or predominantly vertical displacement. That displacement is controlled displacement, and is governed by a motor or drive 58 that is operable to give positive control over the position of footing 52 relative to plate 44.

Carriage 50 also has a second member in the nature of a follower 54 that mates with footing 52. The mating of follower 54 with footing 52 is a movable mating, i.e., such that relative motion may occur between follower 54 and footing 52, carriage 50 also has a resilient suspension 56. Resilient suspension 56 is intermediate footing 52 and follower 54. Resilient suspension 56 may include, and in the embodiment illustrated does include, a set of springs 58 or springs and dampers. In one embodiment either or both of footing 52 and follower 54 may have the form of a substantially stiff polymeric plate which may be made of a Nylon™ or UHMW polymer. In other embodiments the plate or plates may be made of a metal, such as steel, and may be electrically insulated from the body of robot 22. While apparently rigid, such polymeric plates are not rigid in the manner of a thick steel plate, and, being polymeric, has, or have, much higher anelasticity. It is, by the nature of the material, a damper or moderator of high frequency vibration. When seen in plan view, the plate of follower 54 may be, and in the embodiment illustrated is, substantially rectangular, or, rather, has a substantially rectangular mounting fitting connection footprint that mates with the base plate defined by footing 52. Suspension 56 may be non-electrically conductive. Suspension 56 may tend to attenuate relatively high frequency vibration, such that vibration in welding head 24 may tend to be isolated to some extent from robot 22. Springs 58 act between footing 52 and follower 54, such that motion of follower 54 relative to footing 52 will cause extension or compression of springs 58, as may be. That is to say, one end of each spring 58 is mounted to a first anchor point of fixed position relative to footing 52, while the other end of each spring 58 is mounted to a second anchor point of fixed position relative to follower 54. Whether there is a single spring or a set of springs, they have a spring stiffness, k, that defines a force-deflection characteristic between the first part, footing 52, and the second part, follower 54. Given that this relationship defines the mechanical compliance between these components, or members, or elements, it also defines the force-deflection characteristic as between electrode holder 90 and interface plate 44, and, accordingly, as between electrode holder 90 and robot 22 more generally. This stiffness, taken in combination with the sprung mass of welding head 24 will also define a natural frequency in vibration of welding head 24 relative to robot 22.

While carriage 50 may have more than one degree of freedom of motion relative to plate 44 of robot 22, in the embodiment shown carriage 50 is mounted on guideways, slides, or rails 62, 64 so that it has a degree of freedom of motion, in this instance in linear translation, along those guideways, indicated by double-ended arrow ‘A’. In the orientation of welding head 22 shown in FIG. 1, this would yield motion in vertical translation. Clearly, the direction of motion, whether vertical, horizontal, lateral, or some combination of components thereof, will be dictated by the orientation of wrist 50, and is variable according to the programming and operation of robot 22. It is taken as being vertical or predominantly vertical. In the example illustrated, springs 58 are coil springs, and there are cylindrical shafts 66, 68 rigidly mounted to footing 52. Follower 54 has a body that includes cylindrical passages 72, 74 that engage shafts 66, 68 respectively in sliding relationship. That body may include a cross-head 78, or may have structure to which cross-head 78 is attached such that motion of cross-head 78 is the same as motion of follower 54. Springs 58 are mounted concentrically about shafts 66, 68 respectively, and are trapped between the end reactions, or lugs 76 that define the anchor points of footing 52 and the end face of the cross-head 78 that defines the anchor point, or points, of follower 54.

By the nature of its operation, welding head 24 has a rotating drive 80 that induces the welding rod to rotate about its long axis. The speed of rotation is relatively modest. Meanwhile, the power supply operates to pulse discharges to the welding rod. The pulses are released at a frequency on the order of 200 pulses per second, each of the pulses releasing roughly 2 Joules or less (typically 0.2 Joules) of energy. There is a finite time gap, or dead time, or dwell time between the pulses during which there is no current flow. Accordingly, as the welding rod 82 rotates about its axis it makes and breaks electrical contact. With each pulse there is a new spark, and a new micro-deposition of material from the welding rod on the work piece. To the extent that the welding rod is operated at a non-perpendicular angle, i.e., an oblique angle, such that as the welding rod turns it tends to have a conical tip, rather like sharpening a pencil, as successive discharges occur. In a low energy welding process such as ESD, there is no weld pool or puddle, or molten material, and for practical purposes there is no Heat Affected Zone (HAZ).

In the at rest condition, welding head 24 will have a null or neutral, nominally undeflected position. During operation the induced vibration will cause vibratory motion with some displacement to one side or the other of that neutral position, or, alternatively, the tip of welding rod 82 may encounter irregularities or asperities in the surface of workpiece 100. Welding head 24 has a set of sensors that measure the deflection of springs 58. In the embodiment shown, those sensors are Hall Effect sensors 84. Their output is used to control a servo-motor 86 of drive 80, whose operation will be explained below. Sensors 84 may be, and in the embodiment illustrated, are, mounted to monitor displacement of cross-head 78 relative to footing 52. To aid in that monitoring function, cross-head 78 may have, or include, a magnet, such as a bar magnet, or magnets, 85, whose poles, indicated as “N” and “S”, move in proximity to sensors 84, that motion causing a change in output from sensors 84.

In all cases, apparatus 20 and robot 24 are provided with appropriate electrical connectors, pneumatic, and fluid connections, piping, and other ancillary fittings to supply electrical power, whether AC or DC, compressed air, and hydraulic or cooling fluid, such as may be required. These ancillary fittings are understood to be conventional. Apparatus 20 is also provided with sensors such as an inclinometer, as well as motion and force sensors. The feedback from these sensors allows apparatus 20 to adjust as welding is progressing, e.g., as welding rod 82 is being consumed, it may automatically adjust the axial position of carriage 50 to advance toward the workpiece.

Welding head 24, such as may include, or such as may be identified as an ESD electrode holder is shown in FIG. 1 as 90. Electrode holder 90 has an electrode seat or socket, indicated generally as 88, in which an electrode, such as welding rod 82 is mounted. Welding rod 82 has a cylindrical shape and is relatively long and thin, the length being much greater than the diameter. Welding rod 82 may be a semi-conducting material, such as nickel or nickel-based alloys, molybdenum or molybdenum-based alloys, silver or silver-based alloys, titanium or titanium-based alloys such as titanium carbide or titanium di-boride, or such other welding rod material, as may be. The outwardly extending tip of welding rod 82 is seen positioned toward an object with which electrode 82 is to interact, i.e., that is to be subject to welding. That object is identified as “the workpiece”, 100.

Considering again holder 90, there is housing, or back-shell, or body, generally indicated as 70. Housing 70 includes first and second portions 92, 94, which may be referred to as first and second, or left hand and right hand backshell or housing halves or housing portions. First and second housing portions 92, 94 are held together by an array of fasteners such as may be in the nature of threaded cap screws 96 spaced thereabout. A gasket 98 may be captured between portions 92, 94, and compressed by the tightening of screws 96. Both backshell halves may have porting in the nature of vents such as inlet and outlet vent arrays 112 by which air or other gas coolant may be admitted to, and enabled to depart from, the interior of housing 70. The backshell halves may be made of an electrically non-conductive, or electrically insulating, material. The girth of housing 70 may be suitable for being grasped or cradled in the hand of an operator. The general proportions of housing 70 are such that it may have a through dimension in the transverse or y-direction of the order of 2 inches.

As assembled, housing 70 has a forward end, or nose, 106 from which the welding electrode protrudes or advances in operation, and a rearward end or butt, or tail 108 that extends rearwardly. The underside of housing 70 has interface fittings by which housing 70, and therefore electrode holder 90 more generally, are mounted to, or secured to, or engages the mating interface of the movable member of movable fitting defined by follower 54. There may be securements by which housing 70 is immobilized relative to follower 54. In the example shown, the interface fittings of housing 70 have the form of flanges 102, 104, and the securements of follower 64 have the form of clamps 106, 108 that, in use, capture flanges 102, 104 and hold them in place. It is to some extent arbitrary which one of housing 70 and follower 54 has the interface fittings 102, 104 and which has the securements 106, 108. It could be reversed, or both could have suitable sets of interface fittings and separate securements could be used. Threaded fasteners could be used in place of clamps 106, 108. There are possible alternatives. The point is that housing 70 is rigidly mounted relative to follower 54 in use. The use of over-center hand operable devices, such as clamps 106, 108, means that the mounting is releasable, i.e., such that other tools might be mounted instead, or such that a different tool can be swapped in or out for maintenance, and so on.

Electrode holder 90 is electrically connected to the power supply and to the control circuitry, as may be. The motor that rotates the welding rod may be a variable speed motor, the speed of the motor being governed by the programming of the controller between zero and the maximum selectable speed.

Looking at the inside of electrode holder housing 70, each half portion 92, 94 forms a cavity, or half a cavity. The halves are molded to define cavities (or two halves of one cavity) in which to receive the controller, circuitry, and rotating elements of electrode holder 90. There is a first rotating assembly 110. It has an axis of rotation, which is, or may be considered to be, or substantially to be, parallel to the long direction of the main body. In the example illustrated, that axis is also the axis of rotation of welding rod 82.

Proceeding from the rear of the unit to the front, a first drive in the form of a motor 114 is rearmost. The body or housing of motor 114 fits into a pre-formed molded seat in the backshell or housing, there being a corresponding half-seat in the other housing half. The output shaft of motor 114 extends forwardly to mate with the input of a coupling or clutch 118. Main drive shaft 120 has a first end that engages the output side of clutch 118. Clutch 118 is an insulating coupling that electrically isolates motor 114 from shaft 120. Clutch 118 may also compensate for any misalignment between motor 114 and shaft 120.

Near end bearing 122 and intermediate bearing 124 are provided to carry main shaft 120. Near end bearing 122 is located at, or close to, the clutch-connected end of main shaft 120. Intermediate bearing 124 is located at roughly the half-way, or mid-point, of main shaft 120, such that a first portion 126 of shaft 120 is carried between bearings 122 and 124, and a second portion 128 is cantilevered forwardly away from bearing 124. An electrical power pick-up 130 mounts on shaft 120 near first bearing 122. Power pick-up ring, 130 may typically be made of copper, and is connected to the welding power cable 132. In operation, ring 130 is held stationary. Ring 130 is externally accessible through a slot or port covered by external cover plates 134 located on the outside of housing portions 92 and 94 forward of the rearward set of air vent ports. A slip ring 136 is mounted axially forward of pick-up ring 130. Slip ring 136 may be a carbon-lined slip ring. It bears against main shaft 120 and against pick-up ring 130. In operation it carries electrical current from pick-up ring 130 into shaft 120. The distal, or most forward, end of shaft 120 is enlarged at a forward shoulder into a head 138 that has a mating threaded chuck. Chuck 140 and head 138 co-operate to define a seat or accommodation or socket, or receiver, for the inward end of welding rod 82, chuck 140 being releasable to permit replacement of rod 82, and may be tightened to secure rod 82 in place, or to adjust the protruding length of rod 82.

Although it is possible to mount a rotating imbalance as an oscillator on a parallel axis, the embodiment shown does not have such an oscillator, given the automated interruption of the current discharges.

Although gas shields for the use of inert gas delivery to the welding rod are not always used, in the embodiment illustrated a gas shield 146 can be mounted on the outside or forward face of cover plate 142. As shield 146 has a broad or somewhat bulbous or bell-shaped cowling 148 that has a large end that mounts about gas seal 144, and a smaller forward end that carries a tip or cuff 150. Cuff 150 has the form of a ceramic tube such as may be suitable for exposure to high temperature materials, e.g., splatter from ESD welding. When gas shield 146 is in place, shielding gas conveyed by gas line 152 is carried through plate 142 and discharged into the shielded chamber or duct, or passageway, or curtain, defined within cowling 148 and tip member 150, thereby to bathe the electrode in inert shielding gas.

At the connected end, housing 70 has three input connections, the third input being an inert gas supply line 152. The first is an electrode power connection, whether AC or DC, which may, ultimately, be connected to an ESD power source—the same power source of which the opposite pole is connected to the work piece upon which electrode 82 is to be applied. The power source may be indicated generically as a power supply, discussed below. The second input is a motor power source for operation of electric motor 114 within housing 70, in the form of a power cable which may be 120V AC 60 Hz, or 220 V AC 50 Hz, or a 12V DC source, or such other source as may be, and could be a pneumatic source. In the embodiment shown, it may be a 24 V DC source, and motor 114 may be a 24 V DC Pittman variable speed motor having forward and reverse directions. Motor 114 may be termed a low speed brush DC motor. It may have an operating speed range of 0 to 3500 r.p.m. In one application it has a rotational speed of about 300 r.p.m., which would generally be considered a relatively slow speed.

The shielding gas conduit 152 may have the form of a hollow pipe that is formed to run along the inside proximal margin of housing 70. Coolant conduit 152 may be used to conduct an inert gas, such as argon, to electrode rod 82, and may be used for the alternate purpose of providing an inert gas shielding to the coating process. Conduit 152 may be made of a non-electrically conductive material such as a plastic tube. That portion of conduit 152 lying within housing 70 may be made of a metal, such as copper, aluminum, stainless steel, mild steel, or such other metal as may be suitable.

Considering apparatus 20, it may first be taken that the mounting plates are oriented on the robot arm in a vertical orientation of the mounting slides. When welding electrode rod 82 is brought into contact with the workpiece, if there is no force in the springs 58 of the suspension then the entire weight of the welding head assembly will bear on the workpiece through the tip of welding rod 82, which is assumed to contact the workpiece at the oblique angle at which the welding head is mounted. The mass of the welding head may be approximately 1 kg, or of the order of 1 kg. However, as the base plate is moved away from the workpiece (i.e., upward, or predominantly upward) a greater proportion of the weight of the unit is reacted through the robot arm, and a lesser proportion is borne through welding electrode rod 82.

In an ESD process, consistency of the contact force may yield greater consistency of coating results. The operator may select the engagement pressure, or the engagement force, of electrode welding rod 82 with the workpiece as a datum value input to the controller. Given Hooke's law, this datum value will correspond to a specific deflection of springs 58. This “zero point” can be considered to be the “null” deflection of springs 58. The “null” position value can be pre-set to give the desired level of contact force on welding rod 82, which will then correspond to a datum force and datum deflection in springs 58.

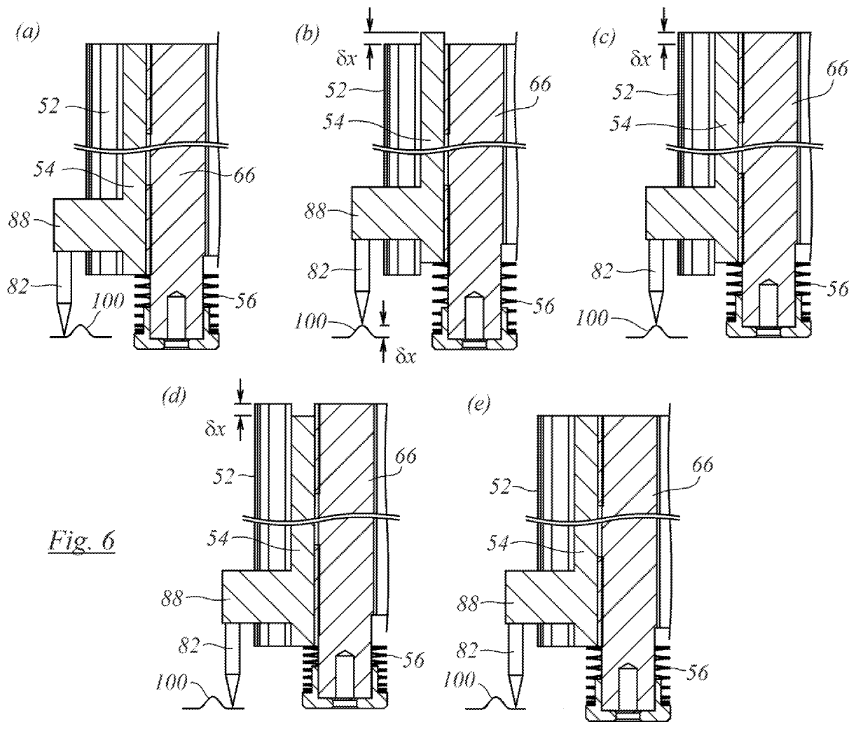

As operation proceeds, the robot may seek to follow a pre-programmed path relative to workpiece 100. This sequence is shown schematically in FIG. 6, in the sequence of steps (a) to (c). In this progression a welding rod 82 is notionally shown schematically as a rigid part of the moving part of the assembly that rides over the surface of workpiece 100. During that progression, the tip of welding electrode 82 may encounter variations in the surface of the workpiece, such as an asperity or protuberance 160 (whose vertical extent and severity is greatly exaggerated for the purposes of illustration in the drawing Figures). As this happens, welding electrode 82 will try to ride over protuberance 160, thereby causing follower 54 to deflect upward relative to footing 52. However, this motion will cause deflection of springs 58 out of the “null” position. The displacement away from the “null” position will be observed by Hall Effect sensors 84. In the illustration, since more weight is being taken by welding electrode rod 82, less weight is being carried in springs 58, so they extend a distance, “delta x”. When this occurs, the programmed controller sends a signal to servo-motor 86 to cause it to drive footing 52 to restore the position of footing 52 to the datum position relative to follower 54, thus restoring the “null” position, and therefore returning the balance of forces to the pre-programmed datum value. Similarly, when welding electrode rod 82 passes over protuberance 160, the weight carried by electrode rod 82 will decrease, and springs 58 will compress to a deflection in the other direction. Once again, this deflection is observed at Hall Effect sensors 84, and the servo-motor 86 is driven in the opposite direction to restore the system to the “null” position yet again. Given that the controller is operating on a frequency in the order of kHz, and the motion of electrode rod 82 is of the order of a few cm per minute, this is not a singular step function but rather a series of finely graduated steps in which the servomotor is constantly adjusting to follow the deviations in the surface of the work-piece. For example, the amplitude of deflection of follower 54 relative to footing 52 is likely to be much less than the full permitted amplitude of motion of 2 mm. It may also be noted that when the apparatus is nearing that range of motion, the robot arm itself will be adjusting toward the null as well. In effect, the fine adjustment of servo-motor 86 is providing greater resolution than the control of the robot arm more generally.

Thus far the assumption has been that apparatus 20 is gravity-dependent, and so therefore applicable in a vertical or predominantly vertical mode. However, to the extent that the footing 52 and follower 54 are joined by a set of springs, deflection in any orientation will cause a loading and deflection of the spring set, with a known force. Where the sprung mass of the welding head is known, and the orientation is known, the component of deflection of the spring set due to the weight of the apparatus can be subtracted from the force of deflection, leaving the component due to the force working to press the tip of electrode rod 82 against the object surface. These components can be determined empirically by rotating the welding head through a full circle and recording the spring deflection during rotation.

In terms of motors, the first drive may have an AC motor or a DC motor. In one embodiment it may be a 12 VDC Pittman Brush Motor with a no-load speed of 6500 rpm and a low speed of 500 rpm. Another embodiment of this motor may have a no-load speed of 6200 rpm, and a low speed of 300 rpm. In another embodiment it may be a 12 VDC servo motor with a speed range of 200-827 rpm; in another embodiment it may be a 24 VDC servo motor with a speed range of 500-1481 rpm. In still another embodiment, the first drive motor may be a DC servo motor having a no load speed of 7200 rpm and a low speed of 2200 rpm. That motor may have a gear reducer on the output side. As the various motors are, or may be, of different sizes, adapters may be used at one or both of the front and rear end to fit the motor into the mounting cavity defined in the molded housing, thereby permitting any of the motor embodiments to be used depending on, e.g., cost and availability. There may be a feed-back control system that includes a digital sensor, or digital encoder, mounted to observe output shaft speed. Inferentially, the monitoring of motor current, which may also be controlled, may typically also be a measure of output shaft torque. Output shaft torque may tend to fluctuate, e.g., when rod contact with the workpiece is broken, or when the rod starts to stick.

The apparatus shown and described herein may be employed for processes that may be termed “Low Energy Welding”. That is, where there may be 1 kJ of energy used in the heating of a resistance spot weld, by contrast in an intermittent electrical discharge weld, the amount of energy used in heating at each contact of the electrode to the workpiece may be of the order of 1 Joule. The heating has very short time duration, is highly localised, and results in the deposition of only a very small amount of material. While the welding is true welding in terms of the fusion of materials through melting, the small energy input may tend to reduce or substantially eliminate any heat affected zone.

As noted, “Low Energy Welding” tends to involve spark deposition of welding or coating material in which the energy of deposit is of the order of 1 J per spark, as opposed to a 1,000 J to 20,000 J of a continuous arc weld. The spark deposition, or “Low Energy Welding” approach may tend to yield a very small heat affected zone. The coating thickness may be in the range of 0.050″ (or less) up to 0.250″ or more depending upon materials. In the past, Low Energy Welding has been a hand-held process, often dependent upon the manual skill and intuition of the operator. Apparatus 20 allows a robot to controls the path of coating or welding in the same manner as would be done with an end mill, while retaining the rotation of the welding rod as in a hand-held unit. Using force, current, and motion feedback, the apparatus adjusts electrode stick-out according to the controlled, programmed pattern of direction, angle, and force. The frequency of the electrical supply and the speed of electrode rotation are all adjustable (or fixed) as welding occurs. Spindle speed is known, because it is monitored, and can be adjusted in real-time, thereby tending to permit a more consistent processing of a workpiece, and promoting consistency of processing from workpiece to workpiece.

Furthermore, being an ESD coating, the thickness of coating is determined by controlling the quantity of deposited materials. The coating may include a first coating layer made of a first material, or first alloy, and a second coating layer or second coating alloy that may be of the same or a different material or different composition of matter. The first material (or alloy) may be compatible with the material of the workpiece substrate. The second material (or alloy) may be compatible with the first material, and so on. Or it may be that successive layers of one material may be built up in increasing thickness by subsequent processing. Although reference is made to a first layer and a second layer, there may be more than two layers.

A premise of ESD coating is that the work piece is, or work pieces are, electrically conductive, and connected to one terminal of the welding power supply. That is, a first terminal of the power supply is connected by a conductor such as wire or cable to welding applicator defined by electrode holder 90. A second terminal is connected to the workpiece, or to an electrically conductive jig or workpiece holder in which the workpiece is held in electrically conductive engagement during the coating process. The second terminal is of opposite polarity to the first terminal. Whether directly or indirectly, the workpiece and the power supply are in electrical connection to form a continuous path for electric current. Similarly, as noted, the other terminal of the power supply is connected to welding electrode holder 90 to form a continuous electrical path to welding rod 82 of opposite electrical polarity to work piece 100 such that an arc will be formed between them when they approach. During operation the applicator is subject to rotation of welding rod 82, as noted above.

In some instances, a coating of ESD deposited material may be a single layer, applied alone. However, in other instances, the process of depositing a layer of coating includes a first step or portion of deposition, and a second step or portion of adding an additional layer or layers, which may be of a different composition of material.

During ESD, the tip of welding electrode rod is in intermittent electrical contact with the work surface. When electrical current is flowing, an arc will form and material of rod 82 will be deposited in a molten form on the surface of the workpiece. There will also be local heating due to the electric current discharge. As noted, each electrical contact results in a low energy local discharge heating of, for example, less than 10 J. Typically the discharge at the point of contact is of the order of 1 J-2 J. The electrical discharge step may involve the switching on and off of current over relatively short time periods on the order of one or two milliseconds. This switching is achieved with programming of the power supply. Similarly, the time period when electrical discharge current is off may be quite short, again, of the order of one or two, or a few, milliseconds. The switching “On” and “Off” may occur rapidly and repeatedly such that while the discharging may be distinct, and cyclic, to a human observer it may appear continuous.

In some instances, the ESD discharge coating may occur in a non-participating environment. That is, the process may be performed in a vacuum chamber or it may be performed in a chamber that has been flushed with a non-participating gas, such as an inert gas such as neon or argon, or a non-oxidizing gas, such as carbon dioxide. The coating process may be followed by one or more steps of post-process heat treatment. Depending on the nature of the alloy from which the work piece is formed, heat treatment may be employed to promote a precipitation hardening effect.

More generally, it can be said that in its various embodiments and examples, the surface treatment discussed herein employs an electrically conductive material in the workpiece, and an electrically conductive material for deposition. That material is a metal alloy material. It may be applied to a metal, or metal alloy as suitable. It may be applied to weldable semi-conductor alloys or to weldable metal-based composites such as Titanium Carbide and Titanium di-Boride. It contemplates that either or both of the work piece and the welding electrode rod material for deposition in various embodiments is, or are, of a material or alloy of material that includes at least one of (a) Nickel; (b) Chromium; (c) Molybdenum; (d) Titanium; (c) Tungsten; (f) Iron (g) Steel (h) Aluminum and Aluminum alloys; and (i) Niobium; (j) Magnesium; and (k) Cobalt. The material may also include one or more of Carbon, Cobalt, Manganese, Vanadium, or other metals that may be found in steel alloys, Nickel-based alloys, Aluminum alloys or Copper alloys. In some cases, work piece 20 is made of a metal alloy of which Nickel, Chromium, and Iron are the largest constituents by wt. %. In some alloys it is more than 40% Nickel, and more than 10% Chromium, two constituents being the primary constituents of the alloy and forming a majority of the material.

In some instances the coating material is formed of an alloy that, by weight, has a higher percentage of Nickel than any other constituent. It may be nearly pure Nickel, i.e., more than 90% by weight. In other embodiments the coating material is made of a metal alloy of which Iron is the largest constituents by wt. %. In other embodiments the coating material is made of a metal alloy of which Cobalt is the largest constituents by wt. %. In still others the coating material is made of a metal alloy of which Titanium is the largest constituents by wt. %. Ultra high purity argon shielding gas can be delivered coaxially around the electrode during deposition, and ESD parameters of 100 V, 80 μF and 150 Hz can be used. The method could have an initial discharge voltage in the range of 30 to 200 V.

Once an ESD coating has been applied, additional layers or sub-layers may be added whether of the same composition or a different composition. These processes may be undertaken with relative control over the area and size of the weld, and of the total energy input in the weld. The total energy input may be set according to the surface area of the weld to be made, and the thickness of the material of the weld.

In operation, the output switching of the power supply is controlled by a main control unit of the power supply. Although the synthetic DC electrical signals, or electrical pulses, however they may be called, may not have the same period or pulse duration, they may have an average rate of discharge, or an accumulated number of signals per elapsed unit of time. For example, there may be 10 to 10,000 signals, or discharges, over a period of 1 second. In some embodiments this rate may be in the range of 1500 discharges per second to 5000 discharges per second. This can be termed a frequency range of 10 Hz to 10 kHz, except that the individual pulses are not cyclic, but rather are discrete, programmed, DC discharges. The operator may program the power supply by adjusting the discharge voltage levels, and the overall energy discharge per unit time (effectively, the pulse voltage, total charge, and the number of pulses per second) to govern the overall heat input into the workpiece interface (e.g., to avoid over-heating). However, once having set those external input parameters, the main control unit is programmed electronically to implement the selections made by the operator.

The operator may also select whether straight polarity is to be employed, and to what extent. Alternatively, the deposition apparatus may sense the rate of consumption of the welding electrode, and, when that rate of consumption has fallen relative to the initial rate by a datum amount, such as ⅕ or ¼ (i.e., to ⅘ or ¾ of the original rate), to initiate a cleaning cycle using straight polarity. The cleaning cycle may include a series, or burst, of straight polarity pulses, or it may be implemented by alternating between forward or straight (i.e., cleaning) and reverse (i.e., deposition) pulses. The number of straight pulses may be different from, (i.e., not equal to), the number of reverse pulses. For example, the ratio of cleaning pulses to deposition pulses may be in the range of 1:1 to 1:10.

ESD operates by discharging a capacitor through a welding rod and work piece sheet, creating a short-duration arc that transfers droplets of material from the welding rod onto the work piece. With repeated capacitor discharge, the small droplets are layered to form thicker coatings. Due to the small droplet size and short pulse durations, heat input and heat buildup is limited, typically to 1 or 2 Joules per discharge, or less; and generally less than 10 Joules.

In respect of materials and methods, in the example commercially available welding rods of may be of relatively small diameter, such as 1.8 mm diameter. The ESD process parameters may be chosen to obtain the fastest deposition rate, e.g., of 310 μF and 140 V at 150 Hz frequency. Shielding gas may be used, such as ultra-high purity argon gas applied coaxially with the welding rod at a flow rate of 10 L/min. Relatively high rates of deposition can be obtained with discharges in the range of 100-2000 μF. The range of voltages observed to yield suitable rates of deposition was 25-160 V.

The method may include reversing polarity of the workpiece and the ESD applicator. The method may include applying powder composition to more than one discrete surface areas of the workpiece. The method may include masking at least one portion of the workpiece. The method may include application of a coating to a surface that is at least one of (a) not flat; and (b) not horizontal.

A Hall-effect sensor is an electronic component that outputs an analog output voltage that is linearly proportionate to the magnetic force in the direction of the magnetic field strength in which it is located. They tend to react very quickly to changes in the magnetic field strength in which the sensor is located, with reaction times such as 0.5 microseconds, and are used in many fields in industry with the advantages of working without physical contact.

Hall-effect sensors are not typically used for electro spark deposition force control systems. While Hall-effect sensors can be used for various applications, they are more commonly employed for measuring magnetic fields, detecting position, and sensing current. In electro spark deposition (ESD) processes, force control is usually achieved through other means such as load cells, force transducers, or piezoelectric sensors that directly measure the applied force. These sensors provide more direct and precise force measurements for control purposes in such systems.

In the force measurement system described herein, the Hall-effect sensors are fixed and the magnets are in motion. The displacement of the magnets is limited using linear slides and springs. Analog-to-digital converters (ADCs) are used to convert the generated analog voltage into a digital signal. In the example, an ADS1115 ADC circuit has a 16 bit resolution (it produces numerical values in the range of 0-65536) and has a sampling rate of 860 samples per second. These values vary depending on the voltage and electronic components used. Hall-effect sensors work linearly, but the magnetic field strength generated by the magnets decreases exponentially, i.e., non-linearly, with the distance from the magnet. The microcontroller converts the observed data into meaningful numerical data by calculation and is sent to the main controller.

ESD coating applicators with oscillators tend to generate vibrations at high frequency. This can cause physical damage to the equipment or to the surface being coated. The use of a non-contact system (i.e., the Hall effect sensors do not contact the workpiece) may tend to prevent damage to the sensors themselves and to the workpiece. Hall effect sensors can be used with relatively high speed systems and tends not to require unreasonably sophisticated or expensive peripherals. Provided that the sensors are suitably protected they are not affected by environmental influences, tend not to need maintenance, and tend not to fail often. The sensors themselves do not require calibration after installation.

The inventor sought to apply an ESD coating while maintaining a relatively constant pressure force depending on a number of variables-such as the coating material used, the surface material to be coated, and the coating parameters. This was to be done, as in the apparatus described herein, in a relatively high precision system that moves on, i.e., follows, the surface of the workpiece.

As described, the apparatus of the system is intended to balance the force on the vertical axis on flat and uneven surfaces, and even on surfaces with moderate surface angles. Running the system vertically, a reference point, or datum value “0”, or null, is obtained by counter-balancing the weight of the applicator on springs. The spring are then working in opposition to gravity.

A previous difficulty with force measurement was the resolution of the load cells was in the range of 800-1000 N, whereas the mass of the apparatus was of the order of 200 grams or less, giving a weight of roughly 2 N. That is, the apparatus needed to observe the force on approximately a 100 g mass with reasonable resolution for both the load cell direct measurement system and the linear actuator which was responsible for the position of the applicator. The Applicator presently described has a sprung mass in the range of 1 kg, and instead of using the direct position control to apply the force, the system (i.e., the welding rod and holders) is suspended on springs. The Hall-Effect sensor board is positioned so that it detects the change in the position as the springs are compressed and extended. The controller is then used to control the position of the foot plate relative to the follower plate to maintain a steady spring force on the work as the ESD is being performed. In the embodiment described, the ESD process elements have been separated from the sensor and position system, allowing the two systems to be optimized on their own, without having the electric current and motors of the ESD process interfere with the force/position control and monitoring of the sensor system.

This may tend to yield a system in which the control sensors, i.e., the Hall effect sensors are relatively inexpensive, and easily obtained commercially, and the control circuitry permits integration with the cnc motion controller of the robot as well so that the controller for the whole system is integrated into one control card.

Use of a Hall-effect system to monitor and control the distance between the electrode and the workpiece in an Electro Spark Deposition (ESD) system as described may tend to permit contactless measurement. That is, the Hall-effect sensors are operable to measure the distance without physical contact, which reduces wear and tear on the sensor and eliminates the risk of contamination or damage due to contact with the workpiece. The non-invasive nature of Hall-effect sensors can be helpful in situations where direct contact is undesirable, such as when working with sensitive or delicate materials. Further, Hall-effect sensors can provide precise distance measurements. In ESD systems maintaining a specific electrode-to-workpiece distance is important in maintaining the quality of the deposition. Hall-effect sensors are less affected by environmental factors like dust, temperature, and humidity compared to some other distance sensors, making them reliable in various conditions. Hall-effect sensors have no moving parts. The lack of moving parts tends to contribute to their longevity and reliability.

It may also be noted that Hall-effect sensors may have a limited range for distance measurements, so they might not be suitable for applications that require a large working distance. In the ESD application process the range of motion is typically of the order of a few millimeters. By their nature, Hall-effect sensors are sensitive to magnetic fields. They may not be suitable for use if the ESD process involves strong magnetic fields as this may affect their accuracy. Achieving accurate distance measurements with Hall-effect sensors may require careful calibration and setup. As noted, the multiple degree-of-freedom described can be oriented in a full range of positions allowing no-load calibration to occur.

The foregoing is a description of an automated Electro Spark Discharge (ESD) welding apparatus 20. It is made up of a combination of (a) a programmable robot 22 and (b) an ESD welding head 24. ESD welding head 24 is mounted to programmable robot 22. ESD welding head 24 is movable to deflect relative to robot 24 according to a force-deflection characteristic. As noted above, that force-deflection characteristic may be defined by the spring constant, k, of the spring, or springs, 58 of resilient suspension 56. As also noted above, the spring constant and the sprung mass, m, of welding head 24 co-operate to define a natural frequency. This natural frequency may be taken as being, or being proportional to, the square root of (k/m).

As also noted, there is at least a first sensor mounted to monitor deflection of welding head 24 relative to robot 22 relative to some datum value, which may be preferred to as the “nul” or “zero” displacement. Alternatively, the first sensor, or multiple sensors as may be, may be used to monitor the force applied by welding head 24 to workpiece 100, i.e., through welding rod 82, whether directly or indirectly by inference. That is, given the spring deflection constant k, measurement of the deflection of springs 58 is equivalent to measuring the force in springs 58. The deflection or force can then be compared to a datum deflection or datum value of force, (or both) as may be. The force applied through welding rod 82 to workpiece 100 can then be determined. Whichever is monitored, welding apparatus 20 is adjustable in response to output from sensors 84 to urge welding apparatus 20 to maintain at least one of the deflection or the applied force, or both, to be restored to, or maintained at, or substantially at, the datum deflection or datum value of force. That is, apparatus 20 seeks to maintain the applied force (and, therefore, implicitly, the spring deflection) at the datum deflection or value as a constant, and if there is a deflection or perturbation to restore the system to the datum, as the welding operation proceeds. In this apparatus there is a degree of freedom of motion between follower 54 (and therefore the sprung mass of welding head 24) and footing 52; and, similarly, a corresponding degree of freedom of motion between footing 52 and the seat of robot 22 defined by plate 44. The adjustment is made by causing the displacement of footing 52 relative to plate 44 to correspond to, or to mimic, or echo, the motion of follower 54, and therefore of welding head 24, relative to footing 52 to return the system to its original datum. The restorative adjustment of footing 52 will tend to lag the initial perturbation of follower 54 by a time interval corresponding to the time period between the polling of the output of sensors 84 by the electronic control system. However, that time period is small, or very small, as compared to the time period between ESD pulse discharges made according to the ESD discharge pulse frequency such that the output force may seek to be maintained at or near a substantially constant value.

The rate of the sensing and digital processing will occur at a much higher frequency than the natural frequency of the suspension. That is, the operating frequency of the digital processor may be of the order of 50 MHz or higher. It may be taken as being greater than 1 kHz. For the purposes of this discussion, the relevant frequency of sampling from the position sensors, i.e., Hall effect sensors 84, is several orders of magnitude higher than the natural frequency of the spring-mass system defined by springs 58 and welding head 24, so that for every potential oscillation of springs 58 there will be many samplings of position such that, relative to the speed of sensing the rate of change of position of follower 54 to footing 52 is very slow, to the point where it approximates a near stationary condition as between successive samplings. Similarly, the frequency of rotation is less than 50 Hz, and the frequency of discharge pulses is typically less than 500 Hz, and may be about 150 Hz. Thus, the time period of sampling of sensor output is of the order of kHz (or MHZ), while the order of magnitude of any of (a) the natural frequency of the sprung mass; (b) the frequency of rotational spinning of welding rod 82; and (c) the frequency of deposition of ESD material are each less than 1 KHz.

Welding apparatus 20 is operable to displace robot 24 relative to welding head 24 in response to output from sensors 84, as when servo motor 86 displaces footing 52 relative to plate 44. As noted, the sensors may be, and in the embodiment shown sensors 84 are, Hall effect sensors.

As noted above, in automated ESD welding apparatus 20, robot 22 has a seat defined by plate 44 to which welding head 24 is mounted. Welding head 24 has an electrode holder 90 and an adapter defined by carriage 50. The adapter, i.e., carriage 50, has a first part, footing 52, that mounted to the seat defined by plate 44 of robot 22. The adapter has a second part, follower 54 to which electrode holder 90 is mounted. That mounting is a fixed position mounting. The first part, footing 52 is movable relative to the second part, follower 54, according to said force-deflection characteristic, k, of springs 58. The first part, footing 52, is connected to the second part, follower 54 by at least one spring 58. There may be more than one spring 58, and the spring constant, k, is taken as being the spring constant of the group, however many springs there may be. The second part may be, and in the embodiment shown is, constrained to move in a single degree of freedom relative to said first part. It is possible for the apparatus to have more than one degree of freedom. For example, there could be another set of slides, plates, and springs (and another restorative drive) mounted to work perpendicularly such that there would be a first force-deflection characteristic in the z-direction and a second force-deflection characteristic in the y or x direction. In the embodiment shown, the single degree of freedom is linear translation, and said linear translation has a predominant component of motion that is normal to instantaneous travel direction of said welding head. That is, robot 22 is conveying welding head 24 over a surface of work-piece 100 that has predominant extents in the x- and y-directions, the major component, or all, or the reaction force in spring 58, and the motion of follower 54 relative to footplate 52, may be in the z-direction. Whereas robot 22 may be programmed to convey welding head 24 over relatively long displacements (in, for example, the x- and y-directions) according to the programmed surface geometry of workpiece 100, of the order of magnitude of several centimeters or inches, or more, the amplitude of the range of motion of welding head 24 relative to robot 22 (i.e., relative to the mounting interface defined by plate 44 of robot 22) in the sprung direction of the degree of freedom is of the order of 25 mm, or roughly 1 inch, or less. It may be of the order of 2 mm, (i.e., 3/32″) or less. As understood, robot 22 is a multiple degree of freedom robot having at least a first extending arm mounted to a base. The welding head 24 is then mounted to the arm distant from the base. The arm may have multiple articulations and “distant” implies at the far end of the articulated arm distant from the shoulder.

In the embodiments shown and described the welding head of the automated ESD welding apparatus has a welding rod accommodation, or seat, or chuck, and a motor such as drive 80 operable to spin a welding rod mounted in that seat or chuck. ESD welding apparatus 20 is operable to seek to maintain a constant deflection force, or datum deflection force or distance, between robot 22 and welding head 24, and accordingly a substantially constant application force as between the tip of welding electrode rod 82 and workpiece 100.

The description also contemplates an automated method of using robot 22 and ESD welding head 24 mounted to robot 22 to apply an ESD coating to a workpiece such as workpiece 100. That method includes providing an adapter such as carriage 50 having a first part such as footing 52 and a second part such as follower 54 in which the first part, footing 52 is mounted to robot 22. Welding head 24 has a welding electrode holder 90 mounted to the second part, follower 54. The second part, follower 54, is movably mounted to the first part, footing 52 according to a force-deflection characteristic, k, namely that defined by springs 58. The method includes using robot 22 to move welding head 24 to follow a programmed path relative to workpiece 100. Welding head 24 is used to deposit an ESD layer from welding rod 82 carried by welding head 24 onto workpiece 100 as robot 22 moves or conveys welding head 24 along the programmed path. The method includes monitoring the position of the second part relative to the first part while welding head 24 deposits an ESD layer on workpiece 100 while welding head 24 moves along the programmed path; and driving the first part to maintain, or to seek to maintain, a constant force, or datum force, between welding rod 82 and the workpiece 100. That is, when the force or displacement of the second part relative to the first part is disturbed, such that it moves away from the programmed datum, the apparatus seeks to return the system to that datum by applying a restorative displacement. That is, the first part and the second part are connected by at least a first spring 58 and the method incudes monitoring deflection of at least the first spring 58 and adjusting position of the first part to seek to maintain or restore a constant deflection in at least said first spring corresponding to the programmed datum.

To that end, the automated method includes providing a motor, such as servo-motor 86, to adjust position of the first part, footing 52, relative to robot 22, to seek to conform to a datum deflection of the second part, follower 54, relative to the first part during ESD deposition on workpiece 100. During operation, the method includes spinning the welding rod at a speed that is less than 3000 rpm while monitoring position of the second part relative to the first part with sensors operating on a digital clock pulse rate of at least 500 KHz.

It may include providing a welding head 24 having a spring mass of at least ½ kg. It may include limiting maximum amplitude of motion between the first and second parts to a maximum of 5 mm or about ¼ inch, or, in a narrower range, to an amplitude of up to 2 mm or about 2/32″. The automated method includes using at least one Hall effect sensor to monitor deflection of the welding head relative to the robot. It may include providing a magnet, or magnets, to the welding head, the magnet being mounted to inter-act with the Hall effect sensors.

The method may also include determining datum deflection of the welding head relative to the robot in a no-load condition throughout a set of orientations permitting calculation of a datum deflection correction that varies with welding head orientation during ESD deposition. That is, at no load, the welding head may be rotated through a full range of angular orientations, and the deflection in springs 58 noted at sampling points throughout the range of rotation, and adjusting then adjusting the datum for any orientation by calculation to yield the same engagement force of the tip of welding electrode 82 with workpiece 100 at such other orientation of engagement as may be. The automated method may include making at least a first ESD coating pass and a second ESD coating pass relative to the workpiece, and a different material composition is deposited in said second coating pass than in the first coating pass. The automated method may includes providing quick-release hand operable securements, such as clamps 106, 108 to hold welding rod holder 90 in a fixed position relative to the second part defined by follower 54.

In summary, the system, or apparatus, enables the Z-axis actuator to apply the desired pressure force to the surface by continuously moving up and down in line with the observed data coming from the sensor. In this operation, the force is measured indirectly rather than directly on the basis of displacement relative to the known stiffness of the springs. The actuator on the z-axis then reacts to the sensor data that is being received 860 times per second.

For example, in a tungsten-carbide (WC) coating application, the force pressing the tip of the welding rod against the workpiece may have a datum value of 30 grams. For this purpose the system is pre-set. With the help of an external scale, the applicator is moved downward until a 30 gram force is obtained. When that desired datum force is achieve, the damper data, i.e., the datum spring deflection is determined as the null, or datum, or “set” value. The desired set value can be changed by re-calibrating the apparatus as suitable. As described above, once the process starts and the system is in operation, the actuator on the Z-axis will move in line with the data observed by the sensors, and the system will tend to adjust, or compensate, to try to maintain the 30 gram force, or such other datum force as may have been set initially.

Various combinations have been shown, or described, or both. The features of the various embodiments may be mixed and matched as may be appropriate without the need for further description of all possible variations, combinations, and permutations of those features. The principles of the present invention are not limited to these specific examples that are given by way of illustration. It is possible to make other embodiments that employ the principles of the invention and that fall within its spirit and scope of the invention. Since changes in and or additions to the above-described embodiments may be made without departing from the nature, spirit or scope of the invention, the invention is not to be limited to those details, but only by the appended claims.

I claim:

1. An automated Electro Spark Discharge (ESD) welding apparatus comprising the combination of a programmable robot and an ESD welding head, wherein:
said ESD welding head is mounted to said programmable robot;
said ESD welding head is movable to deflect relative to said robot according to a force-deflection characteristic;
at least a first sensor is mounted to monitor at least one of (a) deflection of said welding head relative to said robot relative to a datum deflection; and (b) force applied by said welding head against a workpiece relative to a datum value;
said welding apparatus being adjustable in response to output from said sensors to urge said apparatus to maintain at least one of (a) and (b); and
at least said first sensor being a Hall effect sensor.

2. The automated ESD welding apparatus of claim 1 wherein:
said robot has a seat to which said welding head is mounted;
said welding head has an electrode holder and an adapter;
said adapter has a first part that mounted to said seat of said robot;
said adapter has a second part to which said electrode holder is mounted; and
said first part is movable relative to said second part according to said force-deflection characteristic.

3. The automated ESD welding apparatus of claim 2 wherein said first part is connected to said second part by at least one spring and said at least one spring has a spring co-efficient k that defines said force-deflection characteristic.

4. The automated ESD welding apparatus of claim 2 wherein said first part is movably mounted to said seat of said robot, and said apparatus includes a drive operable to adjust position of said first part relative to said robot to conform position of said first part relative to said second part during operation of said welding apparatus.

5. The automated ESD welding apparatus of claim 2 wherein said second part is constrained to move in a single degree of freedom relative to said first part.

6. The automated ESD welding apparatus of claim 5 wherein said single degree of freedom is linear translation, and said linear translation has a predominant component of motion that is normal to instantaneous travel direction of said welding head.

7. The automated ESD welding apparatus of claim 1 wherein said deflection of said welding head relative to said robot has a maximum amplitude of less than 1 inch.

8. The automated ESD welding apparatus of claim 1 wherein said robot is a multiple degree of freedom robot having at least a first extending arm mounted to a base, and said welding head is mounted to said arm distant from said base.

9. The automated ESD welding apparatus of claim 1 wherein said welding head includes a welding rod accommodation and a drive operable to spin a welding rod mounted in said accommodation.

10. The automated ESD welding apparatus of claim 1 wherein said apparatus is operable to seek to maintain a constant deflection force between said robot and said welding head.

11. An automated method of using a robot and an ESD welding head mounted to the robot to apply an ESD coating to a workpiece, said method comprising:
providing an adapter having a first part and a second part; the first part being mounted to the robot; the welding head including a welding electrode holder mounted to the second part; and the second part movably mounted to the first part according to a force-deflection characteristic;
using the robot to cause the welding head to follow a programmed path relative to the workpiece; using the welding head to deposit an ESD layer from a welding rod carried by the welding head onto the workpiece as the robot moves the welding head along the programmed path;
monitoring position of the second part relative to the first part while the welding head is depositing the ESD layer on the workpiece while it moves along the programmed part; and
driving the first part to seek to maintain a constant force between the welding rod and the workpiece.

12. The automated method of claim 11 wherein the first part and the second part are connected by at least a first spring and the method incudes monitoring deflection of at least said first spring and adjusting position of said first part to seek to maintain a constant deflection in at least said first spring.

13. The automated method of claim 11 wherein the method includes spinning the welding rod at a speed that is less than 3000 rpm while monitoring position of the second part relative to the first part with sensors operating on a digital clock pulse rate of at least 500 Hz.

14. The automated method of claim 11 wherein the method includes providing a welding head with a spring mass of at least ½ kg.

15. The automated method of claim 11 wherein the method includes limiting maximum amplitude of motion between the first part and the second part to a maximum amplitude of 1 inch.

16. The automated method of claim 11 wherein the method includes using at least one Hall effect sensor to monitor deflection of the welding head relative to the robot.

17. The automated method of claim 11 wherein said method includes determining datum deflection of the welding head relative to the robot in a no-load condition throughout a set of orientations permitting calculation of a datum deflection correction that varies with welding head orientation during ESD deposition.

18. The automated method of claim 11 wherein said method includes making at least a first ESD coating pass and a second ESD coating pass relative to the workpiece, and a different material composition is deposited in said second coating pass than in said first coating pass.

19. The automated method of claim 11 wherein said method includes providing a motor to adjust position of the first part relative to the robot to seek to conform to a datum deflection of the second part relative to the first part during ESD deposition on the workpiece.

20. The automated method of claim 11 wherein the method includes providing quick-release hand operable securements to hold the welding rod holder in a fixed position relative to the second part.
